(19) United States
(12) Patent Application Publication
(10) Pub. No.: US 2005/0099383 A1
(43) Pub. Date: May 12, 2005

(54) Internet media converter

(76) Inventors: Robert B. Nguyen, Escondido, CA (US); Alan Smith, San Marcos, CA (US); Mike Insalaco, San Diego, CA (US)

Correspondence Address: SNELL & WILMER LLP, 1920 MAIN STREET, SUITE 1200, IRVINE, CA, 92614-7230, US

(21) Appl. No.: 10/780,822

(22) Filed: Feb. 18, 2004

Related U.S. Application Data
(60) Provisional application No. 60/518,403, filed on Nov. 7, 2003.

(51) Int. Cl. H04N 5/335

(52) U.S. Cl. 345/156

(57) ABSTRACT

One embodiment of the invention relates to a signal conversion system for converting an asynchronous signal to an isochronous signal to permit displaying network-delivered digital content on a television device. A computing device acts as the source or storage of digital video content. A conversion device is communicatively coupled to the computing device to receive asynchronous digital video content. Either the conversion device or the computing device identifies two or more reference markers in the asynchronous video stream and determines a clock rate from the known time interval between the two or more reference markers and the amount of video content received between the two or more reference markers. The conversion device generates an isochronous digital video stream having the video content at an interval corresponding to the clock rate. The clock rate in the isochronous signal approximates an original clock rate for the digital video stream.

### CROSS REFERENCE TO RELATED APPLICATION

This non-provisional United States (U.S.) patent application claims the benefit of U.S. Provisional Application No. 60/518,403, filed on Nov. 7, 2003 by inventors Robert B. Nguyen, Alan Smith, and Mike Insalaco, titled “Internet Media Converter.”

### FIELD OF THE INVENTION

Various embodiments of the invention pertain to signal converters. More particularly, one embodiment of the invention pertains to a system, device, and method for converting asynchronous signals to isochronous signals using only the timing information contained in a data stream.

### DESCRIPTION OF RELATED ART

In recent years, delivery of on-demand programming or content (e.g., movies, music, sporting events, etc.) has become a popular feature. It permits consumers to obtain and view desired content (e.g., movie) in the convenience of their home. The relatively high throughput Internet is a convenient way of delivering such on-demand content. For instance, consumers may connect to the Internet on a home computer and order and/or retrieve desired content on demand. While the retrieved content may be displayed or played by the home computer, consumers are used to viewing such content as movies on their television sets. It is often more convenient to listen/view to audio and/or video content on consumers stereo or television since it also permits others to view it.

Content can be downloaded from sources such as the internet and stored on multimedia devices (e.g. computer hard drives, etc.). When this content is transmitted using an asynchronous technology, such as Ethernet, and displayed on audio/video devices, such as televisions or other devices, these display devices typically require huge buffering and complicated processing capabilities in order to process the asynchronous information. This approach is expensive in terms of additional hardware expenditure and also presents a lack of real time performance.

In a home setting there are more display devices (TVs) than Multimedia Center sources, thus this approach is usually cost more overall to the individual household than the present innovative solution.

### BRIEF DESCRIPTION OF THE DRAWINGS

FIG. 1 is a block diagram illustrating a digital video/audio delivery system in which a conversion device converts asynchronous signals from a computer (e.g., IP content) to isochronous signals destined for a set-top box or television set according to one embodiment of the invention.

FIG. 2 is a signal conversion diagram illustrating how signal timing information is reconstructed using only clock information contained in the data according to one embodiment of the invention.

FIG. 3 is a block diagram illustrating an Internet media conversion device according to one embodiment of the invention.

FIG. 4 is a block diagram illustrating an asynchronous-to-isochronous conversion system according to one embodiment of the invention.

FIG. 5 is a block diagram illustrating an asynchronous-to-isochronous conversion system according to one embodiment of the invention.

FIG. 6 is a flow diagram illustrating a method for converting an asynchronous digital audio/video data stream to an isochronous audio/video data stream according to one embodiment of the invention.

FIG. 7 is a flow diagram illustrating a method of calculating a clock rate based on the information received on an asynchronous signal containing a digital video stream.

### SUMMARY OF THE INVENTION

One embodiment of the invention relates to a signal conversion system for converting an asynchronous signal to an isochronous signal to permit displaying network-delivered digital content on a television device. A computing device acts as the source or storage of digital video content. The digital video content having a plurality of reference markers at a known time interval. A conversion device is communicatively coupled to the computing device to receive the digital video content in the form of an asynchronous video stream. Either the conversion device or the computing device identifies two or more reference markers in the asynchronous video stream and determines a packet clock rate from the known time interval between the two or more reference markers and the amount of video content received between the two or more reference markers. The conversion device generates an isochronous digital video stream by transmitting each packet of the original asynchronous video content at an interval corresponding to the packet clock rate. The packet clock rate in the isochronous signal approximates an original clock rate for the digital video stream.

This asynchronous to isochronous conversion may be repeated continuously in real time by the computing device updating the packet clock information sent to the conversion device, and the conversion device continually updating the correct spacing to transmit packets. The asynchronous to isochronous conversion operation may be implemented in hardware electronics and/or software depending on the speed of an onboard micro-controller device in the computing device or conversion device. The conversion device may be located at either the transmit or receive side of the system as long as the communication path from the conversion device to the television or set-top box is isochronous. Digital audio content may be similarly delivered from a computer to a home audio system. For example, some form of timing information (e.g., reference markers) may be added to the original audio content which can then be used to determine the clock rate. The signal conversion from the asynchronous video/audio stream to the isochronous video/audio stream occurs substantially in real-time.

### DETAILED DESCRIPTION

Methods and systems that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

In the following description, certain terminology is used to describe certain features of one or more embodiments of the invention. For instance, “isochronous”, as in isochronous signal, refers to the transmission of data units (e.g., bits, bytes, packets, etc.) at substantially regular or equal time intervals. The term “computer”, as in home computer, broadly refers to any microprocessor-based device which may be configured to execute one or more instructions. The term “clock reference” includes information such as timestamps, a numerical count, and/or a demarcation marker.

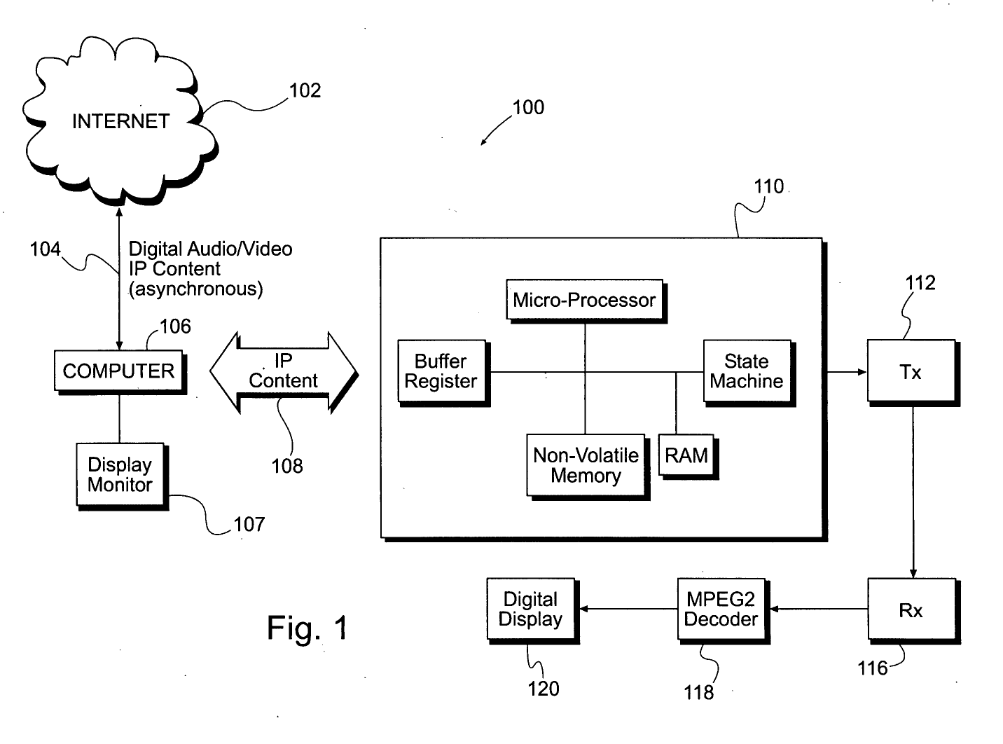

FIG. 1 is a block diagram illustrating a digital video/audio delivery system 100 in which a conversion device converts asynchronous signals from a computer (e.g., IP content) to isochronous signals destined for a set-top box or television set according to one embodiment of the invention. Digital video and/or audio content may be delivered over a network 102 (e.g., internet) via a communication medium or link 104 to a computer 106. The computer 106 may be a home computer configured to receive on-demand video and/or audio over the internet, for instance. Most home computers are connected to a display monitor 107. However, users are not accustomed to viewing video, such as movies, sports, etc., on a computer monitor 107. They typically prefer to view such video content on a larger display such as a television, plasma screen, or projection system. Moreover, computers are typically located in places, such as a home office, which are not conducive to having a several people view the video content (e.g., movie, sport event, etc.). For at least these reasons, one embodiment of the invention provides a system that permits a computer to acquire digital video/audio content over a network (e.g., the internet) and play the content on a television and/or stereo system.

According to one embodiment of the invention, the computer 106 receives the video/audio content as a content file that can be stored by the computer (e.g., desktop computer, multimedia center, etc.). Thus, digital video/audio content may be received and/or stored by the computer 106 for subsequent display on a television/stereo system.

However, one impediment in the system 100 is that the computer 106 receives and sends the video/audio content using asynchronous signals whereas the display devices (e.g., televisions, etc.) expect to receive isochronous signals. That is, computer systems and networks typically send and receive information in the form of data packets which do not have stringent timing requirements whereas video packets, for instance, do. These packets typically compress the video/audio information so that it can be sent more efficiently over a network. When video packets are generated for transmission over dedicated video transmission lines the packets are expected to arrive in the same order in which they are transmitted and within a certain defined time. This timing information is important in reproducing the video/audio content on a television/audio system without the needing a large storage device to receive and buffer the video/audio content.

Through software and/or hardware techniques the content file is asynchronously transmitted by the computer 106 and processed into an isochronous format so display devices (e.g., television sets, plasma display panels, monitors, etc.) can decode the correct audio/video content sent from the computer 106 without having a need for large storage and/or processing capabilities at the receiving display device. This reduces the overall cost to the consumer and at the same time enhances his/her audio/video experience as the display content may be replayed in near real time.

According to one implementation of the invention, all of the necessary processing to convert the asynchronous transmission to isochronous transmission is done by the computer 106 and/or a microprocessor-based conversion device 110 which is communicatively coupled to the computer 106 via a communication link or medium 108. In various embodiments of the invention, the communication link or medium 108 may include a Universal Serial Bus (USB) link, an Ethernet link, or a wireless link. The conversion device 110 may include a custom developed state machine that enables the conversion from asynchronous to isochronous signals.

The conversion device 110 may be coupled to a transmitter 112 which sends the isochronous signals to a receiver 116. The receiver 116 receives the isochronous signals and sends them to a decoder 118 (e.g., MPEG2 decoder) for processing. The decoder 118 receives the isochronous signals, decodes them, and sends the video/audio content to a display device 120 (e.g., digital television, etc.). In this manner, a person may obtain video content from a network (e.g., the internet) or a storage device and display it on their home television screen.

As mentioned above, one problem in sending signals from a computer 106 to a television 120 is that the computer 106 transmits asynchronously and thus, timing information is lost. This timing information is important when sending isochronous signals to the television or cable box 120.

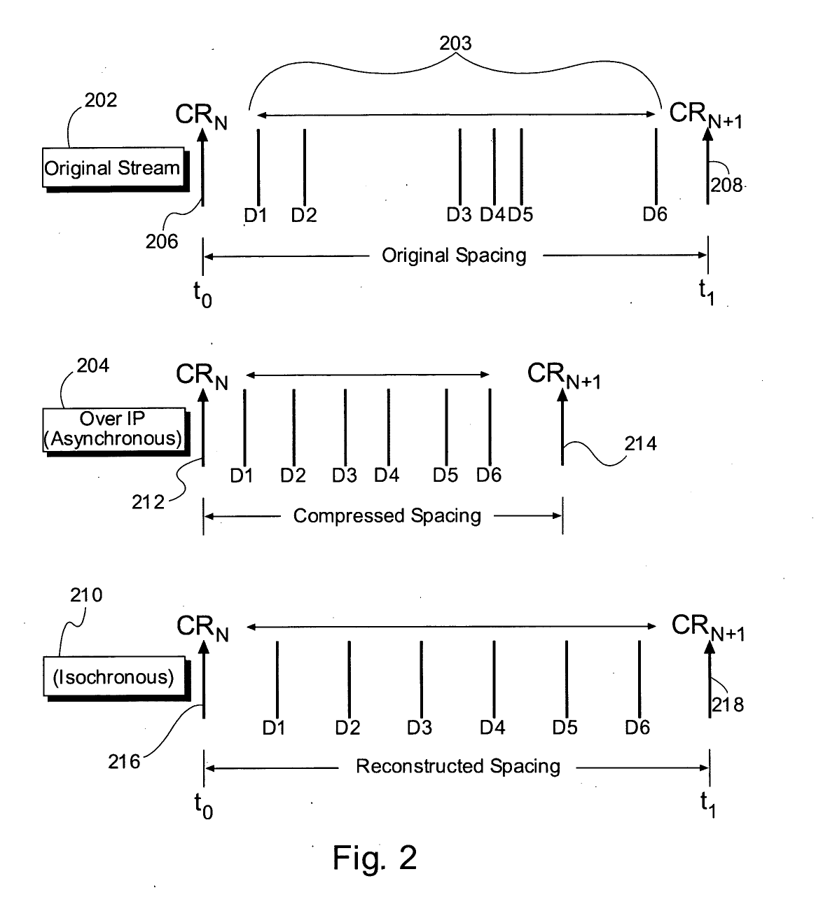

FIG. 2 is a signal conversion diagram illustrating how signal timing information is reconstructed using only clock information contained in the data according to one embodiment of the invention. An original video/audio stream 202 typically includes a plurality of data bits, bytes, or other forms of data representations, D1, D2, D3, D4, D5, and D6, of the video/audio content. At a predefined interval, Clock References (CR) 206 and 208 are inserted into the data stream to demarcate a certain number of units (e.g., bits, bytes, data packets, etc.) between two adjacent Clock References 206 and 208. For example, the Clock Reference markers 206 and 208 may indicate a certain number of bytes between the markers 206 and 208. The Clock References may include a timestamp or some other number which indicates the relative or absolute time interval between a first Clock Reference 206 and a second clock reference 208.

When the data D1, D2, D3, D4, D5, and D6 in the original data stream 202 is packetized for transmission over an asynchronous network (e.g., internet protocol IP), the expected timing/spacing between each byte/unit is lost. Typically, network transmissions occur using asynchronous transmission protocols which compress the data D1, D2, D3, D4, D5, and D6 and ignore any timing information.

Timing information refers to the time interval between a first data unit (e.g., D2) and a second data unit (e.g., D3). Such timing information between data units (bits, bytes, packets, etc.) is important for accurately displaying video data (e.g., D1, D2, D3, D4, D5, and D6) at the correct intervals. For instance, this timing or spacing between data units is necessary for properly constructing an isochronous signal 210 that can be displayed by a digital television or processed by a set-top box feeding a television set.

One embodiment of the invention provides a scheme that permits reconstructing the correct time intervals of video/audio data in an asynchronous signal. A software program operating at the computer 106 may extract and/or calculate the Clock Rate information by using two adjacent Clock References 212 and 214 in the asynchronous data stream 204, and send this information along with the payload to the microprocessor-based conversion device 110. As previously mentioned, the Clock References 212 and 214 may include a timestamp, or other relative or absolute indicator of the time spacing, which can be used to determine the original time between said Clock References 212 and 214.

The Clock Rate may be determined by recognizing the presence of two adjacent Clock References 212 and 214 in the asynchronous data stream 204 and calculating the time interval (t1−t0) between the original Clock References 206 and 208. For instance, the timestamp information in each Clock Reference 212 and 214 can be used to determine the time difference (spacing) between data units D1, D2, D3, D4, D5, and D6. Thus, data units D1, D2, D3, D4, D5, and D6 may be transmitted with the proper delay or spacing in between. An isochronous 210 signal is constructed by evenly spacing the data units D1-D6 between the adjacent Clock References 216 and 218 having a known interval (t1−t0).

Alternatively, the Clock Rate of the original sender may be known, either by convention or set by a standard, or assumed. The Clock References 212 and 214 may serve as markers indicating a particular number of data units between Clock References 212 and 214. Because the Clock Rate is known or assumed and the number of data units or data bytes received between the two Clock References 212 and 214 can be determined, an isochronous signal 210 with evenly spaced data units D1, D2, D3, D4, D5, and D6 may be generated.

According to one implementation of the invention, a computer 110 calculates time interval t1−t0 or Clock Rate by scanning the data traffic. The computer then provides the time interval or Clock Rate, along with the remaining data stream 204, to the microprocessor-based conversion device 110. The conversion device 110, with an onboard state machine, uses the time interval or Clock Rate information to properly send out the data stream content at a constant packet rate as an isochronous signal 210. This allows audio/video devices equipped with a standard audio/video decoder to receive Internet Protocol content and display this content. For example, Clock Rate information contained in an MPEG-2 Transport Stream may be reconstructed by the conversion device 110 (FIG. 1). In various embodiments of the invention, the Clock Rate may be continuously recalculated at every instance of a Clock Reference as new Clock Reference information is extracted from the data stream by the computing device and sent to the conversion device.

In another embodiment of the invention, the entire solution can also be accomplished by the microprocessor-based conversion device 110, provided that the embedded microprocessor has enough processing power. The conversion device 110 can perform the packet Clock Rate extraction at this level, instead of at the computer 106 and provide packet frequency directly to the onboard state machine.

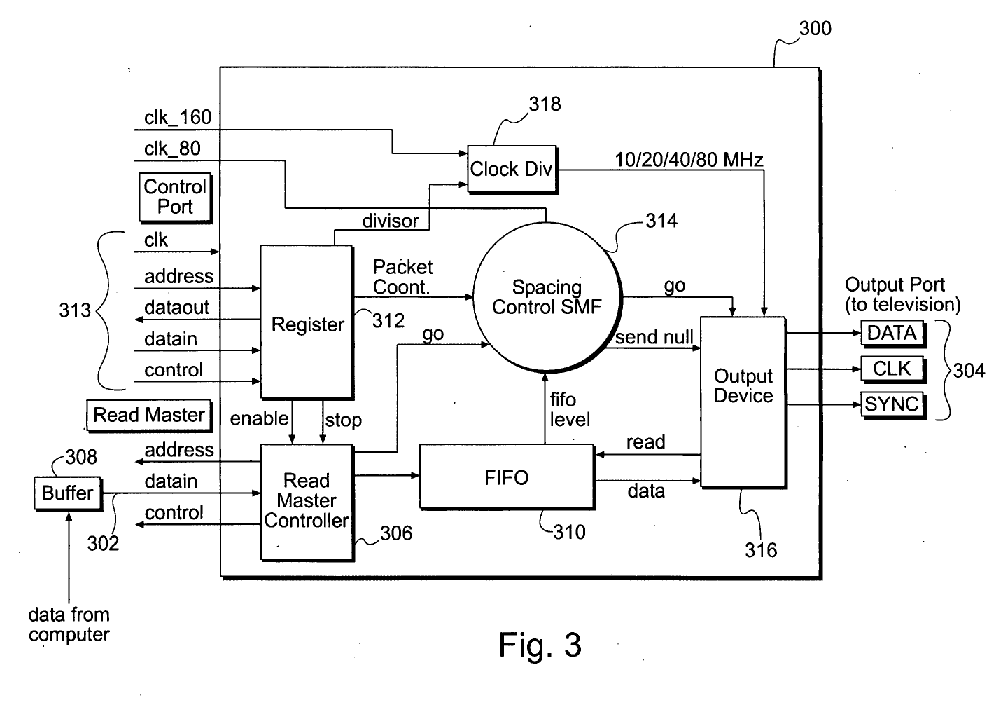

FIG. 3 is a block diagram illustrating an Internet media conversion device 300 according to one embodiment of the invention. The conversion device 300 receives an asynchronous content signal 302 containing video and/or audio data from the computer 106 and buffers the video and/or audio data in a buffer device 302. The conversion device 300 then uses the Clock Rate information embedded in the data stream to send out the information received in a first-in first out manner via an output port 304 to a display device which contains logic to correctly decode the timed data packets. The Clock Rate information may be provided by the computer 106 to the conversion device 300 or it may be determined by the conversion device 300 from the data received. In one implementation of the invention, the conversion device 300 reconstitutes the signal by dividing the number of bytes received in the time interval between two or more Clock References (e.g., 216 and 218 in FIG. 2) over the time interval (e.g., t1−t0) between the two or more Clock References e.g., 216 and 218 in FIG. 2), thus achieving an isochronous signal (e.g., 210 in FIG. 2).

The conversion device 300 includes a read master controller 306 that reads video/audio data packets from a buffer 308 at the computer 106 and places the data in a first-in first-out stack 310. A register 312 also receives control and data information 313, including the Clock Rate, corresponding to the data being received by the read master controller 306. A spacing control state machine 314 retrieves the Clock Rate information from the register 312 and uses it to control the transmission of data from the first-in first-out stack 310 to an output device 316. The output device 316 is coupled to a reference clock 318 and transmits the data to a display unit via output port 304 in an isochronous manner. That is, the spacing control state machine 314 uses the Clock Rate information to indicate to the output device 316 at what time intervals the data from the first-in first-out stack 310 should be transmitted. Other embodiments of the invention may be implemented using other storage or buffering devices in place of the first-in first-out stack 310.

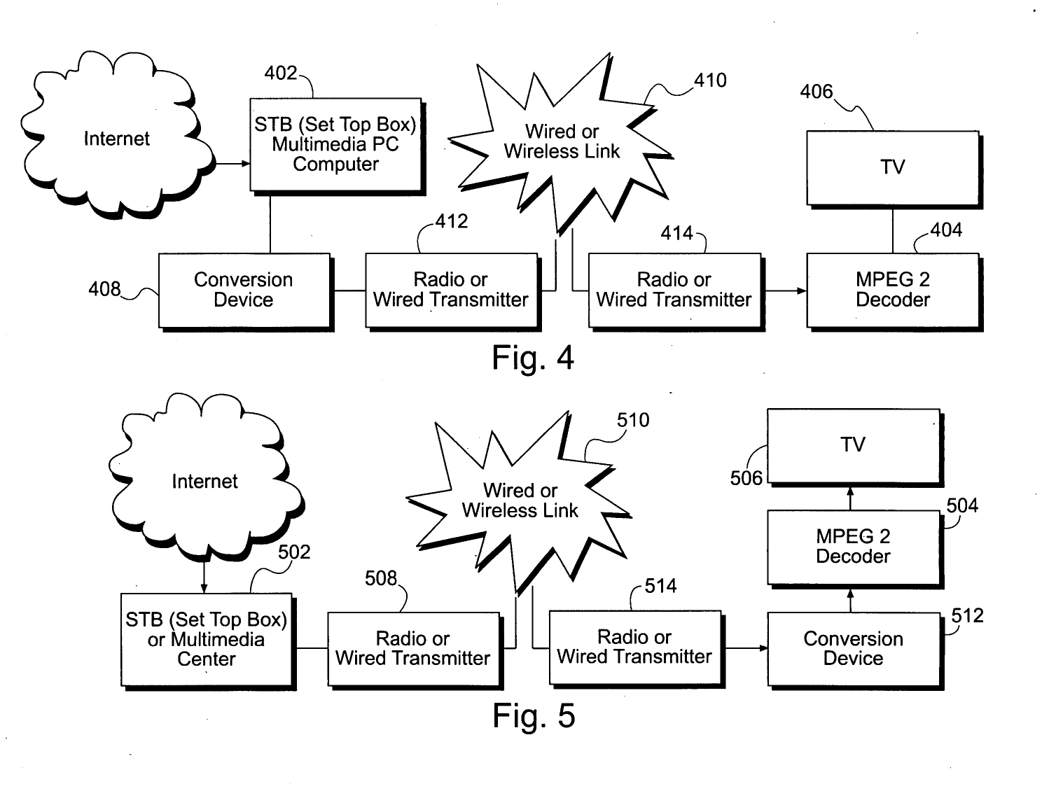

FIG. 4 is a block diagram illustrating an asynchronous-to-isochronous conversion system according to one embodiment of the invention. A computer or multimedia center 402 stores digital video/audio content that may have been obtained in a number of ways, including over a network connection. Instead of displaying the digital video/audio content on the computer's limited display, the video/audio content is to be displayed on a television set 406. However, this requires converting the asynchronous signal originating from the computer 402 into the isochronous signals expected by the MPEG-2 decoder 404 or television 406. The asynchronous-to-isochronous conversion scheme described above provides a solution. For instance, an MPEG-2 Transport Stream file may be stored in the computer 402 and sent by TCP/IP over Ethernet to a conversion device 408 containing timing reconstruction logic. An application program on the computer 402 opens an MPEG-2 Transport Stream file containing audio/video content, locks to the stream using the Packet Start Field, and sends one MPEG-2 Transport Stream packet in each IP packet along with the packet Clock Rate information to the conversion device 408. On reading each MPEG-2 packet, the application program examines each packet for Clock Rate information and recalculates the time distance or interval between packets accordingly. That is, Clock Rate information in a new packet may include a timestamp or counter that can be subtracted from a previous timestamp or counter to determine the original time spacing between packets. In one implementation of the invention the time distance or interval may be continuously sent with each MPEG-2 packet embedded in the IP protocol packet.

The conversion device 408 also contains a TCP/IP stack and is the “end point” for the TCP/IP communications. The payload of the IP packet is an MPEG-2 Transport Stream packet already formatted for sending to an MPEG2 Decoder 404. The MPEG-2 Transport Stream may include timestamps which indicate the relative or absolute time in which each packet was transmitted relative to other packets in the MPEG-2 Transport Stream.

This video/audio information is then transmitted to the MPEG-2 decoder 404 via a wired or wireless medium 410 that is capable of maintaining the packet spacing that has been corrected by the conversion device 408.

FIG. 5 is a block diagram illustrating an asynchronous-to-isochronous conversion system according to another embodiment of the invention. The embodiment illustrated is very similar to that illustrated in FIG. 4, except that the conversion device 512 is now on the receiving side. By placing the conversion device 512 at the receiving side, asynchronous transmissions may be carried from the computer 502 through transmitter 508 and wired or wireless link 510 to receiver 514. The conversion device 512 then converts the asynchronous transmission to an isochronous transmission and sends it to the MPEG-2 Decoder 504 to be transmitted to the television 506.

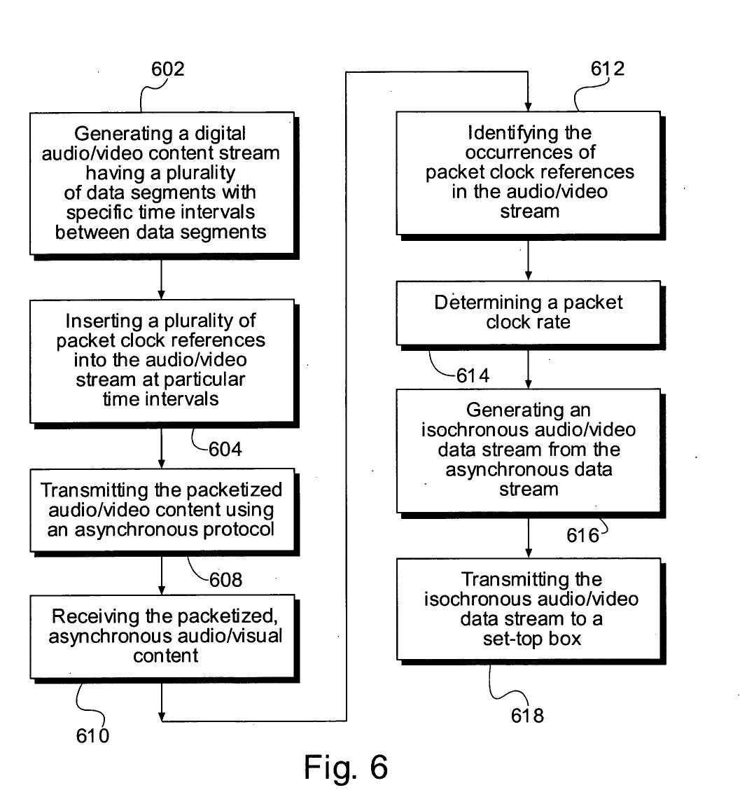

FIG. 6 is a flow diagram illustrating a method for converting an asynchronous digital audio/video data stream to an isochronous audio/video data stream according to one embodiment of the invention. The digital audio/video content may be formed by a stream of data packets with specific time intervals between each data packet 602. A plurality of packet clock reference markers are inserted into the data stream at a predetermined time interval, if they are not already part of the data stream 604. The audio/video data stream is then asynchronously transmitted 608. A receiver receives the asynchronous audio/video data stream 610 and identifies the packet clock references inserted therein 612. In one implementation, because the packet clock references were originally inserted using a known clock rate and the number of data segments (e.g., bits, bytes, packets, etc.) between packet clock references is known, a packet spacing or time interval can be determined 614. In other implementations, the packet clock rate may be determined from timestamps or counters found in the packet clock references.

The packet clock rate can serve to generate an isochronous audio/video data stream in which the audio/video data segments are evenly spaced between the time interval of the packet clock references 616. This isochronous audio/video data stream may then be sent to a set-top box or television for display 618.

One embodiment of the invention permits storing or retrieving multiple video or audio content on a computer and display or playing different content on different televisions or audio systems, at the same time. This may be accomplished with the use of a single multiplexing asynchronous-to-isochronous converting device or multiple converting devices.

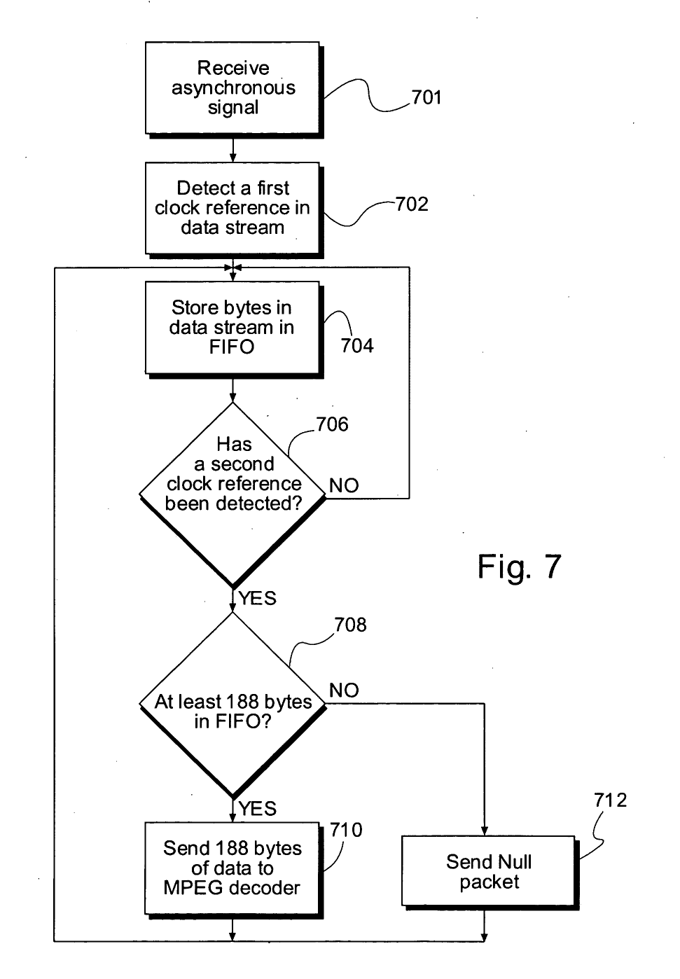

FIG. 7 is a flow diagram illustrating a method of calculating a clock rate based on the information received on an asynchronous signal containing a digital video stream. For example, an original stream of MPEG-2 Transport Stream data contains data packets one hundred eighty-eight bytes (188) in length that are spaced by a plurality of Clock Reference. When these data packets are transmitted across an asynchronous network (e.g., TCP), the timing between these data packets is lost. However, the necessary timing information is embedded in the Clock References. The original clock rate may be extracted the following method.

An asynchronous signal is received 701 and the data stream in the asynchronous signal is scanned for a first clock reference. If a first clock reference is detected 702, then the information or bytes in the data stream are stored in a first-in first-out (FIFO) stack 704. This continues until a second clock reference is detected 706. If at least one-hundred eighty-eight (188) bytes have been stored in the first-in first-out stack 708, then the one hundred eighty-eight bytes are transmitted to the MPEG-2 decoder 710. Otherwise, a null packet is sent 712. This process repeats itself every time a clock reference is detected.

The clock references may include actual timestamps which indicate the relative and/or absolute times. Such timestamps may indicate the original spacing between two clock references. Thus, by using the timestamp information in each clock reference received, packets may be transmitted according to the spacing indicated by these timestamps. For instance, a new timestamp may be subtracted from a previous timestamp to determine the time difference (spacing) between data packets. Thus, a new data packet may be transmitted with the proper delay or spacing from a previous data packet.

In other embodiments of the invention the clock references do not necessarily include an actual timestamp, but instead include a relative or absolute counter. The differences between a new counter and a previous count may be used to determine the spacing or delay between a new data packet and a previous data packet.

In yet other embodiments of the invention, the clock references do not include any timestamp or counter but are merely spacing demarcations. In many applications, the clock rate of the original sender is known, either by convention or set by a standard. Thus, the original clock rate may be assumed or known at the receiving side. The clock references may then serve as data packet demarcations. The data packets are spaced based on the assumed or known clock rate and the number of bytes received between two clock references.

The various asynchronous-to-isochronous converting devices described herein may also be used to display or play any other digital content from a home computer on a television or stereo system. For instance, a user may execute a video game or Internet browsing on the computer but view it on a television set in real-time. Such system may also provide for wired or wireless feedback devices, such as keyboards, joysticks, etc., to permit interaction with the source computer that provides the content.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described preferred embodiment can be configured without departing from the scope and spirit of the invention. Additionally, it is possible to implement the invention or some of its features in hardware, programmable devices, firmware, integrated circuits, one or more machine-readable instructions, software or a combination thereof. One or more aspects of the invention may be embodied in a processor-readable storage medium or machine-readable medium such as a magnetic, optical, or semiconductor storage medium. Therefore, it is to be understood that, within the scope of the appended claims, the invention may be practiced other than as specifically described herein.

1. A signal conversion system, comprising:
a computing device including digital video content, the digital video content having a plurality of reference markers at a known time interval; and
a conversion device communicatively coupled to the computing device, the conversion device configured to
receive the digital video content in the form of an asynchronous video stream, identify two or more reference markers in the asynchronous video stream, determine a packet clock rate from the known time interval between the two or more reference markers and the amount of video content received between the two or more reference markers, and
generate an isochronous digital video stream having the video content at an interval corresponding to packet clock rate.

2. The signal conversion system of claim 1 wherein the conversion device includes
a spacing control device configured to operate as a state machine and determine the time interval between video stream segments in the isochronous digital video stream,
a first-in first-out stack to receive segments of the asynchronous video stream, and
an output device to retrieve the segments of the asynchronous video stream in a first-in first-out basis and transmit them at equal time intervals in the isochronous digital video stream.

3. The signal conversion system of claim 1 wherein the digital video content is an MPEG-2 transport stream data stream.

4. The signal conversion system of claim 1 wherein the conversion of the asynchronous video stream to the isochronous video stream occurs substantially in real-time.

5. The signal conversion system of claim 1 wherein the packet clock rate is determined by the computing device and provided to the conversion device.

6. The signal conversion system of claim 1 the packet clock rate is recalculated at a predetermined number of reference markers.

7. The signal conversion system of claim 1 the packet clock rate is recalculated at every instance of a reference marker.

8. The signal conversion system of claim 1 wherein the packet clock rate substantially corresponds to an original packet clock rate of the video content.

9. A system for transmitting a digital content stream comprising:
a transmission device providing an asynchronous signal containing a digital content stream, the digital content stream having a plurality of reference markers at a known time interval; and
a conversion device communicatively coupled to receive the asynchronous signal from the transmission device, the conversion device configured to
identify two or more reference markers in the digital content stream, determine a first clock rate from the known time interval between the two or more reference markers and the amount of digital content received between the two or more reference markers, and
generate an isochronous digital content stream by spacing the digital content at an interval corresponding to the first clock rate.

10. The system of claim 9 wherein the conversion device includes
a spacing control device configured to operate as a state machine and determine the time interval between a plurality of digital content stream segments in the isochronous digital content stream,
a first-in first-out stack to receive a plurality of segments of the asynchronous video stream, and
an output device to retrieve the segments of the asynchronous video stream in a first-in first-out basis and transmit them at substantially equal time intervals in the isochronous digital video stream, the substantially equal time intervals corresponding to the first clock rate.

11. The system of claim 9 wherein the digital content stream is an MPEG-2 data stream.

12. The system of claim 9 wherein the digital content stream is a digital video content stream.

13. The system of claim 9 wherein the digital content stream is a digital audio content stream.

14. The system of claim 9 wherein the conversion of the asynchronous digital content stream to the isochronous digital content stream occurs substantially in real-time.

15. The system of claim 9 wherein the first clock rate is recalculated at a predetermined number of reference markers.

16. The system of claim 9 wherein the first clock rate is recalculated at every instance of a reference marker.

17. The system of claim 9 wherein the first clock rate substantially corresponds to an original clock rate of the digital content stream.

18. A method for converting asynchronous signals, carrying digital content stream, to isochronous signals, comprising:
identifying two or more reference markers in the digital content stream;
determining a first clock rate from a known time interval between the two or more reference markers and the amount of digital content received between the two or more reference markers; and
generating an isochronous signal, carrying the digital content stream, by spacing the digital content stream at an interval corresponding to the first clock rate.

19. The method of claim 18 wherein the digital content stream is a digital video content stream.

20. The method of claim 18 wherein the digital content stream is a digital audio content stream.

21. The method of claim 18 wherein the conversion of the asynchronous digital content stream to the isochronous digital content stream occurs substantially in real-time.

22. The method of claim 18 wherein the first clock rate is recalculated at a predetermined number of reference markers.

23. The method of claim 18 wherein the spacing of the digital content stream in the isochronous signal approximates an original clock rate for the digital content stream.

24. A method for transmitting a digital content stream, comprising:
generating an asynchronous signal containing the digital content stream, the digital content stream including a plurality of reference markers at a known time interval; and
converting the asynchronous signal to an isochronous signal by identifying two or more reference markers in the digital content stream;
determining a first clock rate from a known time interval between the two or more reference markers and the amount of digital content received between the two or more reference markers, and
generating an isochronous signal, carrying the digital content stream, by spacing the digital content stream at an interval corresponding to the first clock rate.

25. The method of claim 24 wherein the conversion of the asynchronous digital content stream to the isochronous digital content stream occurs substantially in real-time.

26. The method of claim 24 wherein the first clock rate is recalculated at a predetermined number of reference markers.

27. The method of claim 24 wherein the spacing of the digital content stream in the isochronous signal approximates an original clock rate for the digital content stream.

28. A signal conversion device comprising:
a receiver to receive a digital content stream in the form of an asynchronous signal;
a clock detector coupled to the receiver, the clock detector to identify two or more reference markers in the asynchronous signal;
a spacing control device coupled to the clock detector, the spacing control device configured to operate as a state machine and determine the time interval between a plurality of digital content stream segments;
a stack coupled to the receiver, the stack to receive a plurality of digital content stream segments; and
an output device coupled to the stack and the spacing control device, the output device to retrieve the digital content stream segments from the stack and transmit them at substantially equal time intervals to generate an isochronous signal containing the digital content stream.

29. The signal conversion device of claim 28 wherein the substantially equal time intervals at which the digital content stream segments are transmitted in the isochronous signal approximate an original clock rate for the digital content stream.

30. A machine-readable medium having one or more instructions for converting an asynchronous signal to an isochronous signal which when executed by a processor causes the processor to:
receive an asynchronous signal containing a digital content stream, the digital content stream including a plurality of reference markers at a known time interval;
identify two or more reference markers in the digital content stream;
determine a first clock rate from a known time interval between the two or more reference markers and the amount of digital content received between the two or more reference markers; and
generate an isochronous signal, carrying the digital content stream, by spacing the digital content stream at an interval corresponding to the first clock rate.

31. The machine-readable medium of claim 30 wherein the conversion of the asynchronous signal to the isochronous signal occurs substantially in real-time.

32. The machine-readable medium of claim 30 wherein the first clock rate is recalculated at a predetermined number of reference markers.

33. The machine-readable medium of claim 30 wherein the spacing of the digital content stream in the isochronous signal approximates an original clock rate for the digital content stream.
